(19) United States
(12) Patent Application Publication
(10) Pub. No.: US 2010/0031292 A1
(43) Pub. Date: Feb. 4, 2010

(54) VIDEO SYSTEM

(75) Inventors: Sander Bakker, Herten (NL); Jacobus Leonardus Hendrikus Thoolen, Herten (NL)

Correspondence Address: MICHAELSON & ASSOCIATES, P.O. BOX 8489, RED BANK, NJ, 07701-8489, US

(73) Assignees: KONINKLIJKE KPN N.V., The Hague (NL); STREAM GROUP BV, Herten (NL)

(21) Appl. No.: 12/449,202

(22) PCT Filed: Jan. 31, 2008
(86) PCT No.: PCT/EP2008/000774

§ 371 Date: Jul. 28, 2009

Related U.S. Application Data
(60) Provisional application No. 60/898,635, filed on Jan. 31, 2007.

(30) Foreign Application Priority Data
Feb. 15, 2007 (EP) 07003198.4

(51) Int. Cl. H04N 5/445; H04N 7/173

(52) U.S. Cl. 725/43; 725/116; 725/85; 725/41; 725/42

(57) ABSTRACT

A video system for providing multi-media content to a display device. The video system has a first control input for selecting program content to be rendered; an output for providing a video signal for rendering on a display; a controller for including the selected program content into the video signal; means for including first additional multi-media content in the video signal in addition to the selected program content; a second control input for selecting second additional multi-media content to be rendered, where the second additional multi-media content is related to the first additional multi-media content; and means for including the second additional multi-media content in the video signal upon receiving a selection by the user of the second additional content; where the means for including the first additional multi-media content includes the first additional multi-media content into the video signal in response to the reception of the selection of program content via the first control input.

### FIELD OF THE INVENTION

The invention relates to a video system, a system for providing multi-media content to a display device having a video system and a method of providing multi-media content to a display device.

### BACKGROUND OF THE INVENTION

In recent years, television systems have become increasingly advanced with further features being available. In order to make use of many different broadcast media, different analog and digital broadcasting systems are being used. Such broadcast media include terrestrial air, cable and satellite. Such broadcasting systems include traditional analog terrestrial air, cable and satellite broadcasting systems, as well as digital video broadcasting (DVB) systems. Recently, digital systems based on ADSL technology have also been developed for broadcasting television content via analog telephony networks. Most televisions do not support all these broadcasting systems. Instead, a subscriber to a particular broadcasting system typically uses a set-top box which converts the broadcast signal into a video signal (e.g., SCART) that is compatible with the television.

Such set-top boxes often provide more functionality than just converting a single channel of a broadcast programming signal into a video signal. For example, a set-top box may allow a user to receive different television channels and radio channels. That box may also contain a hard disk to store video programs and to enable live pausing and replaying of television programs. Also, such a set-top box, in conjunction with the broadcasting system, may allow a user to watch selected programs that have been broadcast during, e.g., the past 10 days, as well as video-on-demand programs. Such a system may also provide an electronic program guide (EPG) for supplying the user with a current overview of programs to be broadcast. The EPG may be sent with the broadcasting signal and contains information about the channels made available by the broadcaster.

These known systems are also capable of supplying additional multi-media content in addition to regular programs shown on the broadcasted channels. The additional multi-media content, such as advertisements, may be shown to the viewer in the form of commercial breaks interrupting a program watched by a viewer, or as an overlay such as a ticker tape or a picture-in-picture display while watching a program.

The known methods of presenting additional multi-media content possess various disadvantages. The content presented is not well-targeted to an individual user. It is incorporated in the broadcast signal and will reach all users that are tuned to a particular channel, without taking into account an individual's preference or user history. Further, the additional content is presented at moments that can be inconvenient to the viewer. Further, the presence of or interruption by the additional content disturbs the watching experience of the viewer.

### SUMMARY OF THE INVENTION

An object of the invention is to reduce or eliminate at least one of the drawbacks associated with the known systems and to provide a system and a method for providing multi-media content to a display device.

The inventive video system for providing multi-media content to a display device has: a first control input for selecting program content to be rendered; an output for providing a video signal for rendering on a display; a controller for including the selected program content into the video signal; means for including first additional multi-media content in the video signal in addition to the selected program content; a second control input for selecting second additional multi-media content to be rendered, wherein the second additional multi-media content is related to the first additional multi-media content; means for including the second additional multi-media content in the video signal upon receiving a selection by the user of the second additional content; wherein the means for including the first additional multi-media content is arranged for including the first additional multi-media content into the video signal in response to the reception of the selection of program content via the first control input.

The system provides a new way of interaction between a user and a video system. When the user selects program content, he or she would like to view, the system provides the selected program. In addition, first additional multi-media content is rendered to bring some particular information to the attention of the user. For example, the first additional content has a news headline, a brief weather forecast, a sports result, a stock quote, or an advertisement. In addition, the user is given the option to select and display second additional multi-media content which relates to the first additional multi-media content. This way, when the first additional information, brought to the attention of the user without his specific request, triggers the user's interest, the user may obtain more related information by selecting to see the second additional content. The video system will present the additional multi-media content at the moment when the user is switching channels or programs, i.e., at the moment the user is most susceptible to new content. Further, the system provides the user with a direct link to further related (second) multi-media content.

The system has a significantly simplified user interface. In conventional systems, including electronic program guides, the user has to browse manually through available information. This requires navigating through menus or different pages or channels of content, while looking for required information. In the presently inventive system, the user is automatically presented with additional content items and only needs to select to render related content whenever appropriate. Because navigating through menus or different pages or channels of content is not needed to access the first and second additional content, the user interface can be considerably simplified and the user experience enhanced. The user need do nothing until the information relevant to him is automatically presented. Meanwhile, he can view his selected content uninterrupted.

The inventive system is particularly suited to bring a relatively large number of topics (by means of first additional content items to the attention of the user), though only a few of those topics are of interest to the user, where it is not known, a priori, which of the content items will be of interest to the user. Thus, the user is inconvenienced to a relatively small extend, if at all, while he is enjoying selected content while the topics are also being rendered.

The inventive system also provides an improved way of browsing through information. Here, the user is not interrupted while being presented with the additional content. Both the selected content and a first portion of the additional content are presented. This means that the user can enjoy his selected content while simultaneously noting the first portion of the additional content. He then has the option whether to see the second portion of the additional content (which is related to the first portion of the additional content). If he believes, based on the first additional content, that the related second additional content is not then of interest to him, the user need not do anything. His presentation of the selected content is not interrupted. Alternatively, if he decides to also view the second additional content, he can easily select to see it. One of the advantages is that the inventive system determines the interests of the user without bothering him. His selection of the second additional content indicates he is interested; his refraining from selecting the second additional content indicates he is not interested.

The inventive system, embodied within illustratively a home entertainment system, may, for example, be implemented in a television. The inventive system may also be implemented again as part of an entertainment system, as a set-top box to be used in conjunction with a display device. Such entertainment systems may comprise, for example, a display (usually as part of a display device), a surround sound system, a video recorder and the set-top box. This approach makes the system especially user friendly and economic to realize.

In one embodiment of the invention, the means for including the first additional content is arranged for also including in the video signal, together with the first additional content, an indication of a possibility to select the second additional content via the second control input. The indication makes it easier for the user to remember that he may select the second additional content, relating to the first additional content, for rendering.

In an embodiment of the invention, the first additional content may be included in the video signal for a predetermined period of time or, in another embodiment, on regular time intervals.

The inventive system may also contain means for regularly replacing the first additional content. Regularly replacing the first additional content with new content allows the display of current changing information, such as stock quotes, special offers, weather forecasts, news items and others. The content can be refreshed via an information provider connected to the system via a network such as the Internet, a TV cable or an ADSL network.

The controller for including the selected content and the means for including the first additional content are arranged for using at most one third of the area of a display for the first additional content and at least half of the area of the display for the selected content. The content selected by the user is dominant in the video signal, therefore at most one third of the display is used for rendering the first additional content. Proceeding in this manner advantageously enhances the user's viewing experience.

The means for including the first additional content is arranged for including the first additional content as an overlay on top of the selected content in the video signal. This helps to avoid irritating the user because his selected content is presented as the most important information, the first additional information only being presented in an overlay.

The means for including the second additional content is arranged for including the second additional content as a substantially screen-filling presentation in the video signal. Because the second additional information is explicitly selected by the user, then justifiably it can use a substantially complete frame (i.e., a substantially complete display area) for its presentation, using the substantially the full display, thus substantially replacing the presentation of the originally selected content. Preferably, the originally selected content continues to be displayed in a small window (e.g., picture-in-picture).

The inventive system can have an input for receiving a broadcast programming signal, where the content available for selection for rendering via the first control input includes a plurality of channels of the broadcast programming; and a stream selector for providing, under control of the controller, the selected channel for inclusion into the video signal. This advantageously allow the video system to be used in combination with broadcast programming.

The inventive system can also contain a storage medium reader, where the content available for selection for rendering via the first control input includes at least one content item available via the storage medium reader, the storage medium reader being arranged for providing, under control of the controller, the selected content item for inclusion into the video signal. This advantageously allows current information in the form of first and second additional information to supplement the fixed content on the storage medium.

The inventive system also has an electronic program guide, where the content available for selection for rendering via the first control input includes data items in the electronic program guide; the electronic program guide is arranged for providing, under control of the controller, the selected data items for inclusion into the video signal. This advantageously provides a more feature-rich electronic program guide.

The inventive system also has an output for transmitting a background request to a server for the first additional content, the request contains an identifier of the selected content; and an input for receiving the requested first additional content to be included in the video signal. Preferably, the request also contains user information.

Another embodiment of the inventive system has an output for transmitting a request to a server for the second additional content upon receiving the selection of the second additional content; and an input for receiving the requested second additional content to be included in the video signal.

Requesting and receiving the first and/or second additional content at the moment it is needed enables an external entity, such as a content provider or server, to determine the additional content. This facilitates remote control of the additional content, which facilitates keeping the content up-to-date and providing a relatively large number of content items.

In a further aspect, the present invention relates to a system for providing multi-media content to a display device, wherein the system comprises a video system as described above and a server system. The server system has: an output for transmitting a first additional content to a video system for inclusion in a video signal together with content selected by a user of the video system; an input for receiving a request for second additional content, the request being transmitted by the video system upon receiving a selection by the user of the second additional content; and an output for transmitting the requested second additional content to the video system for inclusion in the video signal.

The server system may further have an input for receiving a request for the first additional content, the request being transmitted by the video system upon receiving a selection of content to be rendered, and the request contains an identifier of the selected content. In addition, the server system may have an output for transmitting video broadcast programming which has multiple channels available for selection by the user of the video system.

In a further embodiment of the present invention, the server system also has: a user database server containing user information, preferably keywords reflecting interests, needs and/or preferences of the user; an application server connected to the user database capable of providing, upon request, the video system with the user information and an electronic programming guide, preferably a mini-electronic programming guide, containing detailed information on the program content selected by the user of the video system; a campaign manager server having references to the first and second additional multi-media content; and one or more content servers containing the first and second additional multi-media content. By using the electronic programming guide of the application server, the system need not use the electronic programming guide provided by the broadcaster via the broadcast signal.

In yet another embodiment of the inventive system, the campaign manager server is capable of selecting appropriate first additional multi-media content on the basis of the user information references to first and/or second additional multi-media contents which reflect the interests, needs and/or preferences of the user. The campaign manager server is capable of registering the selection of second additional multi-media content.

The application server and user database server are capable of registering and logging the selection of first and second additional multi-media content.

Another aspect of the invention relates to methods of providing multi-media content to a display device. In one embodiment, the inventive method has the steps of: selecting program content to be rendered; providing a video signal for rendering on a display; including the selected program content into the video signal; including first additional multi-media content in the video signal in addition to the selected content in response to selecting the program content; selecting second additional content to be rendered, wherein the second additional content relates to the first additional content; and including the second additional multi-media content in the video signal upon receiving a selection by the user of the second additional content.

Another embodiment of the inventive method of providing multi-media content to a display device has the steps of: receiving program selection information; retrieving, in response to the reception of the program selection information, first additional multi-media content; transmitting a video signal to the display device for displaying the first additional multi-media content in a first sub-area of the screen of the display device; and transmitting a video signal to the display device for displaying in a second sub-area of the first sub-area, an indication allowing a user, upon selection of the indication, to retrieve and display the second additional multi-media content, wherein the second additional multi-media content is related to the first additional multi-media content.

The inventive method may further have the step of: transmitting, in response to the reception of the program selection information, a request to a server for retrieving the first additional content. Further, the request may contain user information.

The invention further relates to a content providing unit for providing multi-media content to a display device. In one embodiment, the unit has: means for receiving program selection information; means for retrieving, in response to the reception of the program selection information, first additional multi-media content; means for transmitting a video signal to the display device for displaying the first additional multi-media content in a first sub-area of the screen of the display device; and means for transmitting a video signal to the display device for displaying in a second sub-area of the first sub-area, an indication allowing a user, upon selection of the indication, to retrieve and display the second additional multi-media content, wherein the second additional multi-media content is related to the first additional multi-media content.

The content providing unit may also have means for transmitting, in response to the reception of the program selection information, a request to a server for retrieving the first additional content. Further, the request may contain user information.

The present invention further relates to a display device, preferably a television, a personal digital assistant, a mobile phone, a set-top box or a computer having a video system or a content providing unit as described above and to a computer program product directly loadable into an internal memory of a computer which contains software code portions for performing the above-described steps, when the product is run on a computer.

### BRIEF DESCRIPTION OF THE DRAWINGS

The invention will be illustrated with reference to the attached drawings, which schematically show illustrative embodiments according to the invention.

Various aspects of the invention will be further elucidated and described with reference to the drawings, in which:

FIG. 1 depicts aspects of a television broadcasting system;

FIGS. 2 and 3 each depicts a corresponding diagram of a screen layout and a remote control;

FIG. 4 depicts a diagram of a screen layout;

FIG. 5 depicts a diagram of a screen layout and a remote control;

FIG. 6 depicts a diagram of a screen layout;

FIG. 7 depicts a diagram of an embodiment of the present inventive system;

FIG. 8 depicts a flowchart of processing steps of an embodiment of the inventive method;

FIG. 9 illustrates an exemplary embodiment of the server system;

FIG. 10 depicts an embodiment of the video system of the present invention;

FIG. 11 depicts an exemplary process of retrieving the first additional multi-media content; and

FIG. 12 depicts an exemplary process of retrieving the second additional multi-media content.

### DETAILED DESCRIPTION OF EMBODIMENTS

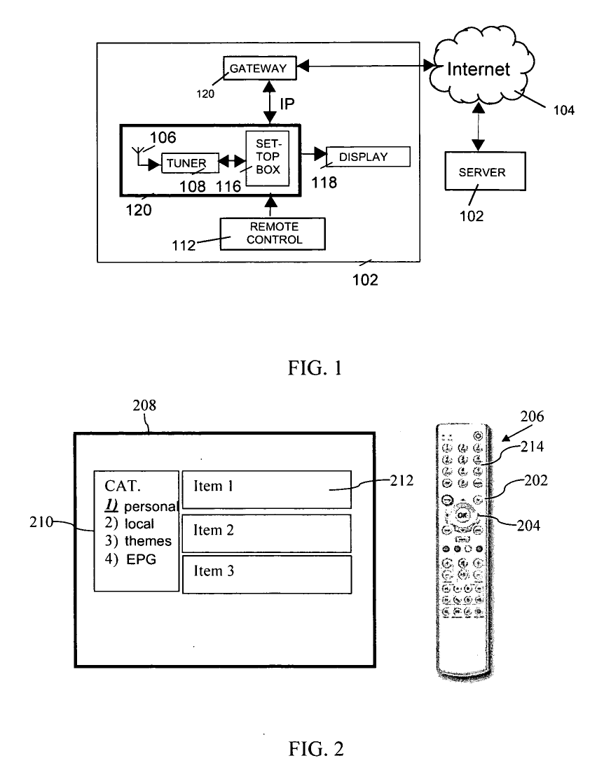

FIG. 1 depicts aspects of a conventional television broadcasting system. As shown, the antenna 106 receives a broadcast signal, containing programming, from a broadcaster. The signal contains a plurality of program channels. TV tuner 108 is connected to antenna 106 via a coax cable. The TV tuner is connected via a digital USB connection with set-top box 116. The set-top box also has an IP network connection to connect to the Internet 104 via internet gateway 120. Via Internet 104, the set-top box 116 also can connect to a data center comprising server system 102. Set-top box 116 produces a video signal for rendering on display device 118. The video signal is provided to the display device via a SCART interface. Remote control 112 is used to control operation of set-top box 116. Set-top box 116 and TV tuner 108 are integrated into single unit 120. The display device may be a television, a personal digital assistant (PDA), a mobile phone, a computer or any other device suitable for displaying the broadcast signal to the user.

FIG. 1 simply provides an illustrative non-limiting context in which the features disclosed herein may be applied. The TV tuner and the set-top box may also be provided separately, and the TV tuner may also be connected to a satellite dish, a cable network or an ADSL connection instead of or in addition to the antenna. The functionality of the separate units shown in this figure may be combined in a single unit, or may be distributed over several units as appropriate. Also, the connections to external networks via antenna 106 and Internet 104 are illustrative and may be replaced by any other communications means. A SCART interface to this display (though not specifically shown in FIG. 1) may be replaced by other connectors such as DVI or HDMI.

FIG. 2 illustrates some of the features provided by set-top box 116. These features are controlled by a user via remote control 112, 206. Screen shot 208 shows menu 210 with various content categories such as: Personal, Local content, Themes, and an electronic program guide (EPG). The user can navigate through these categories using up/down arrows and OK button 204. Content items 212 (e.g., item 1, item 2, item 3) appear on the right hand side of the screen shot 208. Here the content items in the selected category “1) personal” are displayed. Using button 202 on remote control 206, the user can switch to a TV channel. A particular channel can be selected by using numeric keys 214 available on remote control 206.

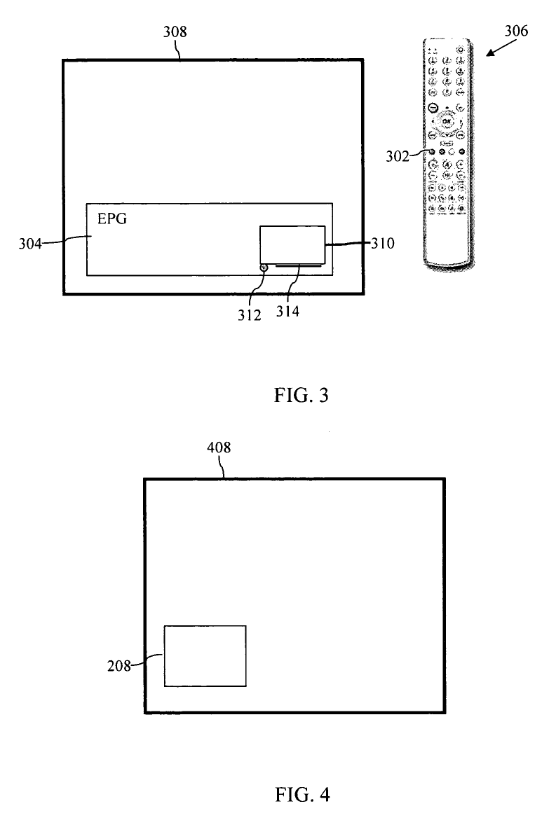

FIG. 3 depicts a first exemplary screen layout 308 of a selected channel. At the same time that the channel content is rendered on display device 118, information about the channel programming (e.g., a title of the current show) is provided in box 304. The box also contains first additional multi-media content 310. The additional multi-media content may be information in any multi-media form, i.e., text and/or static or moving graphics and/or sound. Below or in the vicinity of the first additional multi-media content, button 312 is displayed in a specific, predefined color, for example red, next to a short line of text indicating the presence of second additional multi-media content which relates to the first additional content 310. This indicates to the user that pressing corresponding red button 302 on the remote control 306 will provide second additional multi-media information 314 relating to the first additional information. When the user presses red button 302 on remote control 306, he selects second additional multi-media content, where the second additional content relates to the first additional content. For example, first additional content 310 contains a logo of an animal channel or an image of an animal. Text 314 contains the name of a TV channel or slide show about animals.

FIG. 4 depicts the second additional multi-media content in screen shot 408, which may represent a slide show about animals. The slide show content is retrieved by set-top box 116 from server system 102. The page is rendered after the user presses red button 302. The originally selected channel content, which was previously shown in full-screen 308, now is rendered in small display box 208.

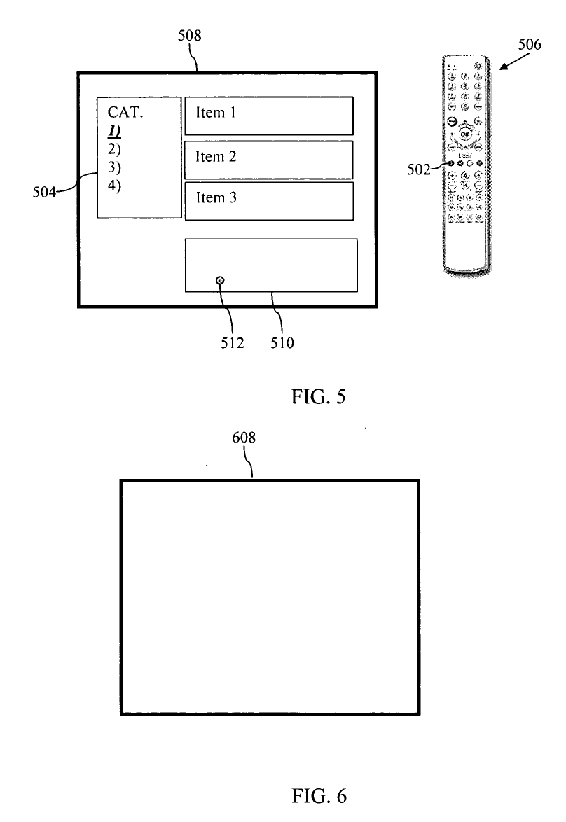

FIG. 5 shows another exemplary screen layout 508 and of remote control 506. The screen display contains electronic program guide information 504. First additional multi-media content 510 is shown near the bottom of the screen, together with indication 512 of a button on remote control 506 that the user can press to see second additional multi-media content relating to the first multi-media content. First additional information 510 may comprise a company logo.

FIG. 6 depicts a screen layout comprising second additional multi-media content relating to first additional multi-media content 510. This screen is provided to the user after pressing button 502 indicated by indicator 512 shown in FIG. 5. Screen 608 may contain an advertisement about some of the products of a company corresponding to a company logo shown in content 510.

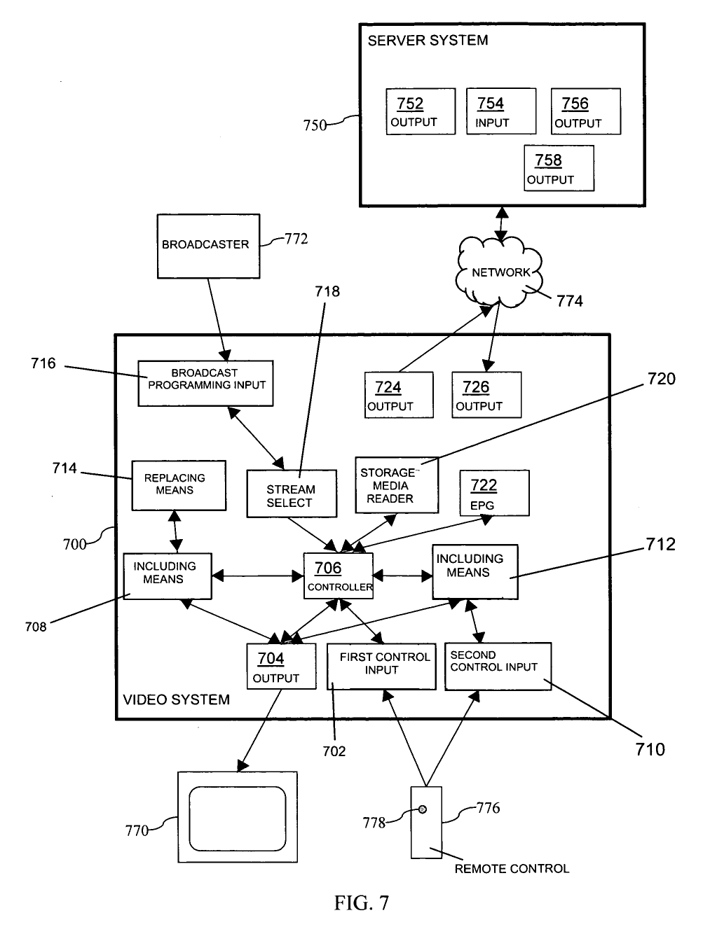

FIG. 7 depicts a system for providing multi-media content to a display device comprising video system 700, server system 750 connected to the video system 700 via network 774 and display device 770 which may be connected to the video system via a video connector, remote control 776 communicating with the video system 700 via infrared communication, and broadcaster 772 sending video content in a plurality of channels via a medium (e.g., DVB-T, or a cable television network) to video system 700. Video system 700 has first control input 702 for selecting program content to be rendered. The user sends commands to first control input 702 via the remote control 776. Upon receiving the command to select, for example, a channel of content, input 702 passes the command to controller 706 which then includes the selected program content in a video signal that is provided to output 704 for rendering on display device 770.

Video system 700 also has means 708 for including first additional multi-media content in the video signal in addition to the selected program content. The first additional multi-media content may be different from the selected program content. The first additional content may however also relate to the selected program content. It may, for example, represent more detailed information about a topic currently being rendered. Alternatively, the first additional content is unrelated or only slightly related to the selected content. For example, the first additional content may contain an advertisement for a product, or a hint for a user that information has become available, for example, that a breaking news story is about to start on another channel.

Video system 700 also comprises a second control input 710 for selecting the second additional multi-media content to be rendered. For example, button 778 on remote control 776 is dedicated for selecting the second additional multi-media content. This allows a one-click selection of the second additional content. The control signal corresponding to button 778 is sent by remote control 776 to second control input 710. Video system 700 also contains means 712 for including the second additional multi-media content in the video signal upon receiving the selection by the user.

Video system 700 may be implemented as a functional unit, such as a content providing unit, which can be inserted in a television set, a computer, or a personal digital assistant or in a separate set-top box.

Preferably, the first additional multi-media content is shown to the user via output 704 and display device 770 immediately or shortly after receiving the selection of content to be rendered via the first control input. The first additional multi-media content may be displayed together with meta-information about the content being rendered (for example, channel name, program title, title and start time of next program). The additional content may also be displayed at, for example, regular time intervals. The system also has means 714 for regularly replacing the first additional content. The first additional content is dynamic. It can be replaced every time it is displayed (i.e., every time after receiving the selection via the first control input), or the first additional content can be the same every time it is selected via first control input 702 is made during a particular predetermined time interval. The first additional content items may be provided by broadcaster 772 or by server system 750.

Means 708 for including the first additional multi-media content may also include an indication for the user to select the second additional input for rendering. The selection is performed via second control input 710 and button 778 on remote control 776. For example, the first additional multi-media content includes the indication. Alternatively, a separate indication is displayed next to the rendering of the first additional content or a predetermined sound is included in the video signal for rendering.

At most, one-third of the screen area is used by means 708 for the first additional multi-media content, and at least half of the screen area is used by controller 706 for the selected content. For example, a bar or a small rectangular region near the bottom of the screen is used for the first additional multi-media content. The combination of the two content types by means 708 and controller 706 into a single video signal occurs by means of known digital and/or analog video processing. For example, known overlay techniques are used to include the first additional multi-media content as an overlay on top of the selected content in the video signal. The second additional multi-media content, included by means 712, is a substantially screen-filling presentation. The program content originally selected via first control input 702 is disregarded or is rendered in a relatively small area of the screen.

Video signal 704 selected via first control input 702 is provided by means of video broadcaster 772 to broadcast programming input 716 of the video system. This signal may be an analog or digital signal received via an antenna or cable, or it may be one or more digital video streams provided via an IP network and/or a DSL network. Server system 750 may contain the broadcaster 772 thereby forming a IPTV platform. The broadcast programming signal present at input 716 provides a plurality of channels to be selected for rendering via first control input 702. Controller 706 sends a corresponding control signal to stream selector 718 which parses the signal received by input 716 to extract the selected channel content and which provides the extracted content to video output 704.

Video system 700 also contains storage medium reader 720. This reader may have a hard disk for temporarily storing content received via input 716 from broadcaster 772. Storage medium reader 720 may also support removable media such as DVDs. First control input 702 is used to select content items available via broadcast programming input 716 and/or via storage medium reader 720. If an item is selected from storage medium reader 720, controller 706 starts processing the selected item and provides the corresponding video signal to video output 704. The selected content item is accompanied by first additional content.

Video system 700 also has electronic programming guide (EPG) 722. The EPG may obtain broadcast programming information from broadcaster 772 and/or server system 750. Preferably, EPG is obtained from the server system. The EPG is used to browse and select an interesting content item for rendering. Thus, the content items available for being selected to be rendered via first control input 702 include data items in the electronic program guide. Such data items may include textual information as well as still images and trailers of TV programs. Upon selection of such a data item, means 708 may include first additional multi-media information into the output signal provided by video output 704. This first additional information is presented on display 770 together with the requested data item.

Video system 700 has output 724 for transmitting a background request to a server for the first additional content, the request containing an identifier of the selected content. This request is sent upon receiving the selection of content via first control input 702. The request may also be sent at regular time intervals. The requested first additional content is received from server 750 via input 726 for inclusion in the video signal. The request may also comprise user information such as a zip code, a smart card number, a name and address of the user. Output 724 is also used for transmitting a request to a server for the second additional content. This can be done upon receiving the selection of the second additional content, or in the background before receiving the selection of the second additional content. Input 726 is also used for receiving the requested second additional content to be included in the video signal. The first additional content contains, for example, an image or text or a movie. The second additional content contains, for example, a TV channel, a website, a photo, a slideshow, or a video.

Server system 750 has an output 752 for transmitting a first additional content to video system 700 for inclusion in a video signal together with content selected by a user of the video system. Server system 750 also has input 754 for receiving a request for second additional content. The server system also contains output 756 for transmitting the requested second additional content to the video system for inclusion in the video signal upon receiving the request. Input 754 also receives the request from video system 700 via the network 774 for the first additional content. The server system also has output 758 for transmitting video broadcast programming containing a plurality of channels available for selection by the user the video system. Output 758 can be used instead of or in addition to broadcaster 772. Server system 750 can be implemented, for example, in a single high-end computer or in a computer farm having a network of a plurality of servers.

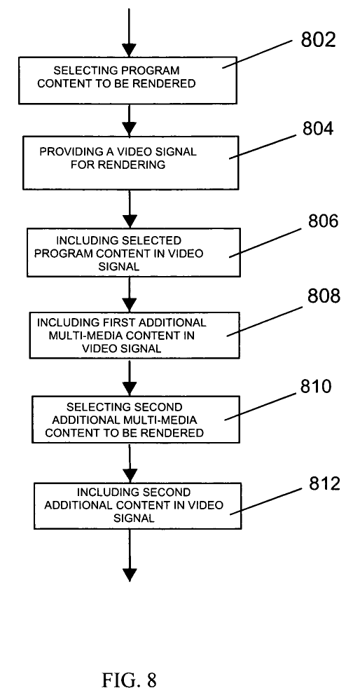

FIG. 8 depicts, in flowchart forum, processing steps of an embodiment of the inventive method have the steps of selecting 802 program content to be rendered; providing 804 a video signal for rendering on a display device; including 806 the selected program content into the video signal; including 808 first additional multi-media content in the video signal in addition to the selected program content in response to selecting the program content; selecting 810 second additional multi-media content to be rendered, wherein the second additional multi-media content relates to the first additional multi-media content; and including 812 the second additional content in the video signal upon receiving a selection by the user of the second additional content. These program steps may be implemented in a computer program.

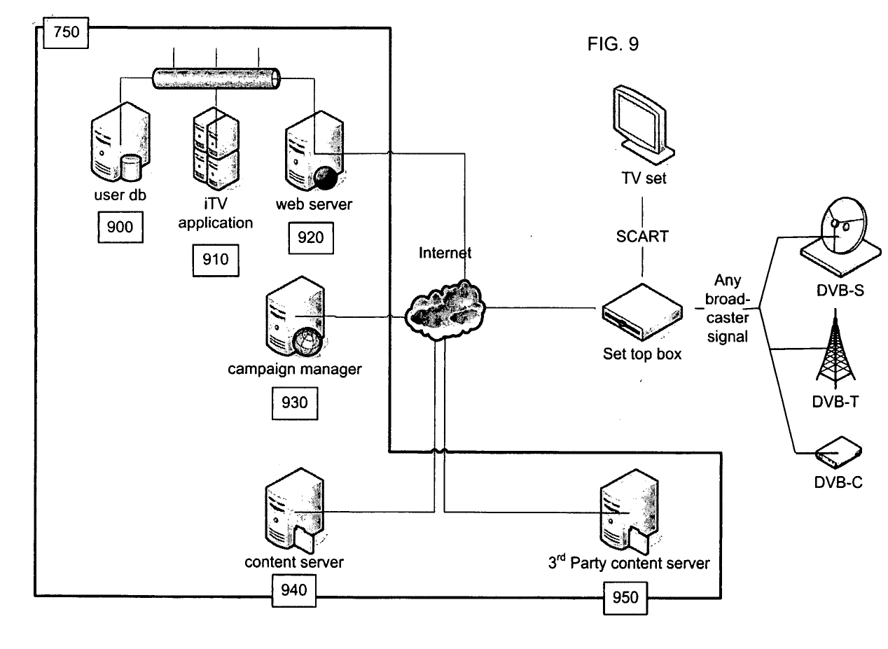

FIG. 9 depicts an exemplary embodiment of server system 750 (see FIG. 7). As shown in FIG. 9, server system 750 contains a number of servers with different functionality. User database server 900 has data relevant for selecting and providing the first additional multi-media content to a specific user. Such data may be stored in a user profile containing specific user information necessary for selecting multi-media content which is dedicated to specific interests and/or needs of the user. This profile may also contain a logbook that specifies that user's usage history, such as his previous selections of second additional multi-media content. The user database server can also contain a table with keywords. These keywords may be provided by the user or by other sources and can be used by system 750 to select relevant multi-media content. Application server 910 is connected to the user database server and is capable of retrieving, upon request, user data from the user database server. Based on all the user data, the application server can determine and select the appropriate keyword(s) to be used in retrieving first additional multi-media content, each time a request for first additional multi-media content is received. These keywords may reflect the interest, needs and/or lifestyle of a particular user. Further, the application server is capable of providing an electronic program guide (EPG). Web server 920 connects all set-top boxes to the application server. The web server can be further connected to campaign manager 930, and one or more content servers, which may contain internal content server 940, owned by the owner of the content providing system, and/or external, third-party content server 950. The campaign manager server has a database containing all references to first and secondary additional content. These references may be in the form of URLs or one or more IP tables containing the IP addresses of the servers having the additional content. The content servers contain the multi-media content to be displayed on the display devices.

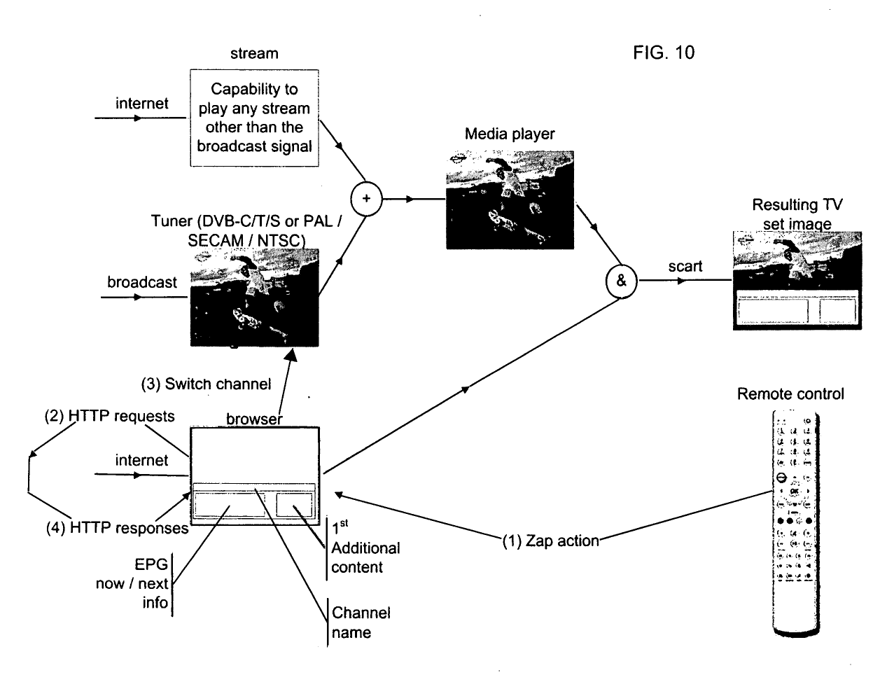

FIG. 10 depicts a further embodiment of video system 700 implemented in a set-top box (STB) and schematically shows an exemplary process flow implemented by the set-top box when selecting a channel (zapping).

The set-top box is connected via a television tuner to a broadcast signal containing the channels provided by the broadcaster and, optionally, to the Internet. The set-top box is further connected to server system 750 and a display device. The set-top box has a controller which allows the user to control (e.g., start/stop/pause) the multi-media streams of the broadcast signal or any other Internet sources. The controller may use a media player to control the streaming. The controller can also request the television tuner to change to another channel provided by the broadcast signal or any other internet source. The controller may be handled by the remote control actions of the user.

In a first step of the scheme shown in FIG. 10, the user sends, via the remote control, program selection information, e.g., in the form of a zap action, to the controller of the set-top box. In response to the reception of the program selection information, the controller sends, in a second step, a signal to the television tuner for setting the channel to the channel requested by the user and a request to server system 750. This request may have the form of an HTTP request. In response to the request, server system 750 provides the set-top box, in a third step, with a signal which may contain a dedicated electronic programming guide, in the form of illustratively a mini-electronic programming guide, containing detailed information about the newly selected channel. The signal further has first additional multi-media content, which may contain information dedicated to the specific interests and/or needs of the user of the set-top box. In a fourth step, the controller merges the broadcast signal of the selected program channel with the signal provided by the server system. In a fifth and last step, the merged signal is displayed by a display device.

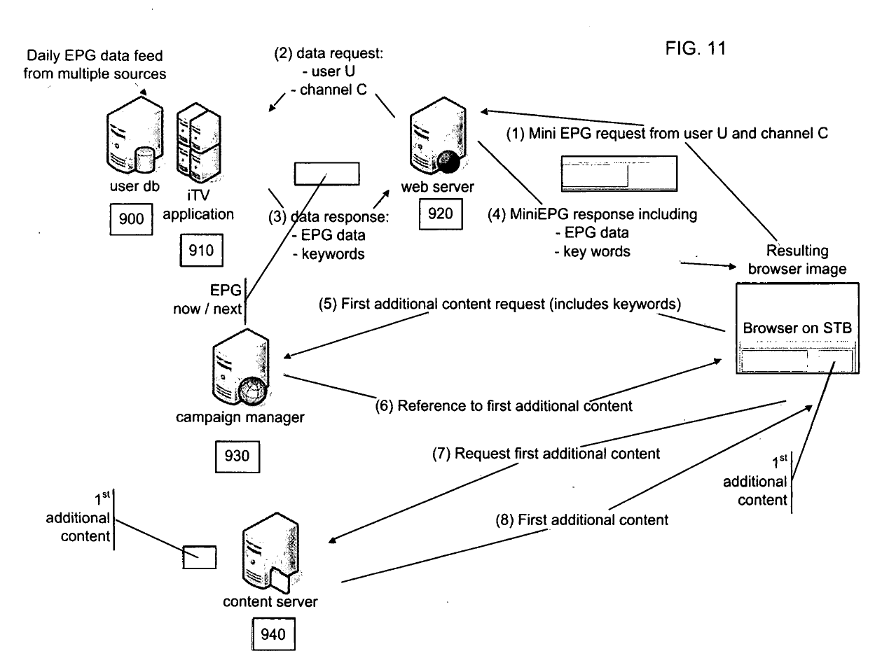

FIG. 11 depicts, in enhanced detail, an embodiment that exemplifies the retrieval of first additional content as discussed above in conjunction with FIG. 10. FIG. 10 schematically illustrates the steps involved in retrieving first additional multi-media content from the server system. When a zap action is performed by the user (e.g., by pressing a channel selection button of the remote control), the controller of the set-top box will automatically send in a first step a request for a mini-electronic programming guide to web server 920. Preferably, the request may contain information about the user and the channel. The web server, which acts as a gateway between the set-top box and the application server, forwards the request in a second step to application server 910. In a third step, the application server and the user data base server respond to the request by providing the web server with the relevant electronic programming guide or a mini-guide and a set of keywords. The web server subsequently forwards the guide and the keywords in a forth step to the set-top box. The relevant electronic programming guide data is stored in the application server and updated via a daily EPG feed from several sources. The set of keywords is based on user specific information stored in the user database server.

In a fifth step, the set-top box sends, in response to the reception of the electronic programming guide data and the set of keywords, a request to campaign manager server 930. The request to the campaign manager contains one or more keywords of the set of keywords received by the set-top box. The campaign manager server may be owned and managed by the owner of server system 750 or may be a third-party campaign manager server.

In a sixth step, the campaign manager server extracts, on the basis of the keywords, location information of (part of) the first additional multi-media content and sends this location information to the set-top box. The campaign manager server may also provide a part of the first additional multi-media content.

The set-top box subsequently retrieves in a seventh step (a part of) the additional multi-media content, from a source, e.g., content server 940, indicated by the location information, by sending a request to the content server referred to in the location information. The content server may be owned and managed by the owner of the server system 750 or may be a third-party content server. The content server transmits in a eighth step (part of) the first additional content to the set-top box. The set-top box thereafter merges the first additional content received with the broadcast signal comprising the selected program content.

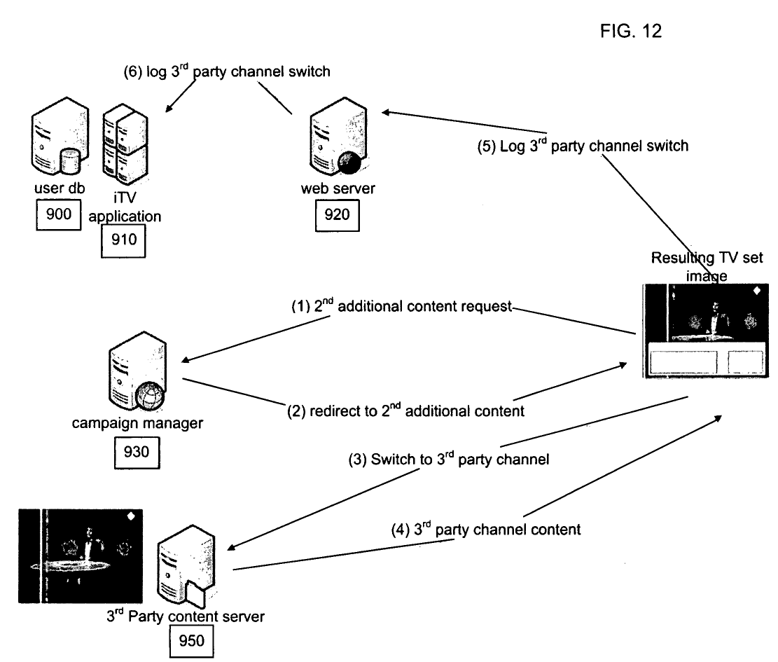

FIG. 12 depicts, in further detail, an embodiment that exemplifies the retrieval of second additional content as discussed above in conjunction with FIG. 10. FIG. 12 schematically illustrates the steps involved in retrieving second additional multi-media content from the server system.

The sequence of events is triggered by the user pressing remote control button 302 associated with the first additional content. In a first step, the controller of the set-top box will send a request for the second additional content to campaign manager server 930. The request allows the campaign manager system to register that the user has requested second additional content. This way the campaign manager server is capable of registering click rates for specific campaigns or advertisements. In response to the request, the campaign manager sends, in a second step, location information of the second additional multi-media content to the set-top box. In a third step, the request is redirected to a third-party content server (e.g., content server 950), which, in a forth step, sends the selected multi-media content to the set-top box. Thereafter, in a fifth step, the controller in the set-top box reports the events regarding the selection of the second additional multi-media content via the web server to the application server. The application server stores this information and may use this for future keyword selections for new user requests that require first additional content.

It will be appreciated that the invention also extends to computer programs, particularly computer programs on or in a carrier, adapted for putting the invention into practice. The program may be in the form of source code, object code, a code intermediate source and object code such as partially compiled form, or in any other form suitable for use in implementing the inventive method. The carrier, on which the program is stored, may be any entity or device capable of carrying the program. For example, the carrier may illustratively include a storage medium, such as a ROM, a CD ROM or a semiconductor ROM, or a magnetic recording medium, such as a floppy disc or hard disk. Further, the carrier may be a transmissible carrier such as an electrical or optical signal which may be conveyed via electrical or optical cable or by radio or other means. When the program is embodied in such a signal, the carrier may be constituted by such cable or other device or means. Alternatively, the carrier may be an integrated circuit in which the program is embedded, the integrated circuit being adapted for performing, or for use in the performance of, the relevant method. Further, the invention may be implemented by means of hardware comprising several distinct elements, and by means of a suitably programmed computer. In the device claim enumerating several means, several of these means may be embodied by one and the same item of hardware.

The above-mentioned embodiments illustrate rather than limit the invention. Those skilled in the art will be able to design a wide variety of alternative embodiments based on the teachings above and all without departing from the scope of the appended claims.

1. A video system for providing multi-media content to a display device, comprising:
a first control input for selecting program content to be rendered to a user so as to define selected program content;
an output for providing a video signal for rendering on a display;
a controller for including the selected program content into the video signal;
means for including first additional multi-media content in the video signal in addition to the selected program content;
a second control input for selecting second additional multi-media content to be rendered, wherein the second additional multi-media content is related to the first additional multi-media content; and
means for including the second additional multi-media content in the video signal upon receiving a selection by the user of the second additional content;
wherein the means for including the first additional multi-media content is arranged for including the first additional multi-media content into the video signal in response to the reception of the selection of program content via the first control input.

2. The video system recited in claim 1 wherein the video system comprises a set-top box for use in a home entertainment system.

3. The video system recited in claim 1 further comprising means for regularly replacing the first additional content.

4. The video system recited in claim 1 wherein the means for including the first additional content is arranged for also including in the video signal, together with the first additional content, an indication to the user of a possibility for the user to select the second additional content via the second control input.

5. The video system recited in claim 1 wherein the controller for including the selected content and the means for including the first additional content are arranged for using at most a predefined position of an area of a display to render the first additional content, and at most a second predefined position of the area of the display to render the selected content.

6. The video system recited in claim 1 wherein the means for including the first additional content is arranged for including the first additional content as an overlay on top of the selected content in the video signal.

7. The video system recited in claim 1 wherein the means for including the second additional content is arranged for including the second additional content as a substantially screen-filling presentation in the video signal.

8. The video system recited in claim 1 further comprising:
an input for receiving a broadcast programming signal, where content available for being selected to be rendered via the first control input includes a plurality of channels of the broadcast programming; and
a stream selector for providing, under control of the controller, a selected one of the channels for inclusion into the video signal.

9. The video system recited in claim 1 further comprising:
a storage medium reader, where the content available for being selected to be rendered via the first control input includes at least one content item available via the storage medium reader, the storage medium reader being arranged for providing, under control of the controller, the selected content item for inclusion into the video signal.

10. The video system recited in claim 1 further comprising:
an electronic program guide, where the content available for being selected to be rendered via the first control input includes data items in the electronic program guide; the electronic program guide being arranged for providing, under control of the controller, selected data items from the electronic program guide for inclusion into the video signal.

11. The video system recited in claim 1 further comprising:
an output for transmitting a background request to a server for the first additional content, the request comprising an identifier of the selected content; and
an input for receiving requested first additional content, provided by the server, to be included in the video signal.

12. The video system recited in claim 11 wherein the request also comprises user information.

13. The video system recited in claim 1 further comprising:
an output for transmitting a request to a server for the second additional content upon receiving the selection of the second additional content; and
an input for receiving requested second additional content, provided by the server, to be included in the video signal.

14. The video system recited in claim 1 wherein the first additional content comprises image or text.

15. The video system recited in claim 1 wherein the second additional content comprises a TV channel, a website, a photo, a slideshow, or a video.

16. A server system for providing multi-media content to a display device, the system comprising a video system according to claim 1 and a server system, the server system comprising:
an output for transmitting a first additional content to a video system for inclusion in a video signal together with content selected by a user of the video system;
an input for receiving a request for second additional content, the request being transmitted by the video system upon receiving a selection by the user of the second additional content; and
an output for transmitting requested second additional content, provided in response to the request, to the video system for inclusion in the video signal.

17. The system recited in claim 16 wherein the server system further comprises an input for receiving a request for the first additional content, the request being transmitted by the video system upon receiving a selection of content to be rendered, and the request comprising an identifier of the selected content.

18. The system recited in claim 16 wherein the server system further comprises an output for transmitting video broadcast programming comprising a plurality of channels available for selection by the user the video system.

19. The system recited in claim 16 further comprising:
a user database server having user information reflecting interests, needs and/or preferences of the user;
an application server connected to the user database server and capable of providing, upon request, the video system with the user information, and an electronic programming guide comprising detailed information on program content selected by the user of the video system;
a campaign manager server comprising references to the first and second additional multi-media content; and
one or more content servers comprising the first and second additional multi-media content.

20. The system recited in claim 19 wherein the campaign manager server is capable of selecting, in response to user information, references to first and/or second additional multi-media contents which reflect the interests, needs and/or preferences of the user.

21. The system recited in claim 19 wherein the campaign manager server is capable of registering the second additional multi-media content.

22. The system recited in claim 19 wherein the application server and user database server are capable of registering and logging the selection of first and second additional multi-media content.

23. A method of providing multi-media content to a display device, the method comprising the steps of:
selecting program content to be rendered so as to define selected program content;
providing a video signal for rendering on a display;
including the selected program content into the video signal;
including, in response to selecting the program content, first additional multi-media content in the video signal in addition to the selected content;
selecting second additional content to be rendered, wherein the second additional content relates to the first additional content; and
including the second additional multi-media content in the video signal upon receiving a selection by the user of the second additional content.

24. A method of providing multi-media content to a display device, the method comprising the steps of:
receiving program selection information so as to define received program selection;
retrieving, in response to the received program selection information, first additional multi-media content;
transmitting a video signal to the display device for displaying the first additional multi-media content in a first sub-area of the screen of the display device;
transmitting a video signal to the display device for displaying in a second sub-area of the first sub-area, an indication allowing a user, upon selection of the indication, to retrieve and display the second additional multi-media content, wherein the second additional multi-media content is related to the first additional multi-media content.

25. The method recited in claim 24 further comprising the step of:
transmitting, in response to the received program selection information, a request to a server for retrieving the first additional content.

26. The method recited in claim 25 wherein the request comprises user information.

27. A content providing unit for providing multi-media content to a display device, the unit comprising:
means for receiving program selection information so as to define received program selection information;
means retrieving, in response to the received program selection information, first additional multi-media content;
means for transmitting a video signal to the display device for displaying the first additional multi-media content in a first sub-area of the screen of the display device;
means for transmitting a video signal to the display device for displaying in a second sub-area of the first sub-area, an indication allowing a user, upon selection of the indication, to retrieve and display the second additional multi-media content, wherein the second additional multi-media content is related to the first additional multi-media content.

28. The content providing unit recited in claim 27 further comprising:
means for transmitting, in response to the received program selection information, a request to a server for retrieving the first additional content.

29. The content providing unit recited in claim 28 wherein the request comprises user information.

30. A display device, a personal digital assistant or a computer, or a mobile phone or a set-top box comprising a video system recited in claim 1.

31. A computer readable medium having computer executable instructions therein, such that the computer instructions, when executed by a processing system can use the system to perform the method recited in claim 23.
